(19) United States
(12) Patent Application Publication
(10) Pub. No.: US 2003/0178243 A1
(43) Pub. Date: Sep. 25, 2003

(54) Steering-shaft train

(76) Inventors: Christian Mosler, Stuttgart (DE); Heinz Raub, Stuttgart (DE)

Correspondence Address: KENYON & KENYON, ONE BROADWAY, NEW YORK, NY, 10004, US

(21) Appl. No.: 10/385,227

(22) Filed: Mar. 10, 2003

(30) Foreign Application Priority Data
Mar. 8, 2002 (DE) 102 10 368.2

(51) Int. Cl. B62D 5/06; B62D 5/04

(52) U.S. Cl. 180/443; 180/422

(57) ABSTRACT

A steering-shaft train between the steering handle and steered vehicle wheels of a vehicle steering system includes an input shaft on the side of the handle and an output shaft on the side of the wheels, as well as a transmitting device, which motively couples these shafts at a transmission ratio controllable by a motor that is mounted in a self-locking manner or arranged to be self-locking. The motor may be positively coupled to the one shaft on the side of the motor shaft and connected to the other shaft on the side of the motor housing, in a rotatably fixed manner.

### CROSS-REFERENCE TO RELATED APPLICATIONS

The present application claims priority to Application No. 102 10 368.2, filed in the Federal Republic of Germany on Mar. 8, 2002, which is expressly incorporated herein in its entirety as reference thereto.

### FIELD OF THE INVENTION

The present invention relates to a steering-shaft train between the steering handle or steering wheel and steered vehicle wheels of a vehicle steering system, having an input shaft on the side of the handle and an output shaft on the side of the wheels, as well as a transmitting device that motively couples these shafts at a transmission ratio controllable by a motor.

### BACKGROUND INFORMATION

It is believed to be understood that an overriding-drive unit can be positioned between the steering handle and the steered wheels, see, e.g., German Published Patent Application No. 100 00 219, the overriding-drive unit being connected on one side to the steered vehicle wheels for their steering movement, and being connected on the other side to the steering handle and a servomotor, via two transmission inputs, and the servomotor being controlled as a function of parameters. Different transmission ratios between the steering handle and steered wheels are produced inside a wide manipulating range as a function of speed and rotational direction. In addition, automatic steering actions may be also be taken with the aid of the servomotor.

According to German Published Patent Application No. 100 00 219, the servomotor is mounted with a motor housing stationary with respect to the vehicle and drives a worm gear, which is coaxial to the wheel-side transmission output and interacts with a motor-side drive worm in a self-locking manner.

It is an object of the present invention to provide, in a steering-shaft train, low frictional losses in operating phases in which the motor is stopped.

### SUMMARY

The above and other beneficial objects of the present invention may be achieved by providing a steering-shaft train as described herein.

For example, this object may be achieved by positively coupling the motor to one shaft, i.e., the input or output shaft, on the side of the motor shaft, and by connecting the motor to the other shaft, i.e., the output or input shaft, on the side of the motor housing, in a rotatably fixed manner.

An example embodiment of the present invention is based on stationary-mounting the motor housing, either with respect to the input shaft on the side of the steering handle or with respect to the output shaft on the side of the wheels, i.e., the motor housing forms a part that is connected to one of these shafts in a rotatably fixed manner. A consequence of this may be that, in the case of a stopped motor between the input and output shafts, no friction-encumbered transmission parts whatsoever of the transmission device may have to become active or may have to be moved with respect to the shafts.

An example embodiment of the present invention may provide particularly low-friction, force and torque transmission between the input and output shafts.

Since the motor housing may be rotated along when the input or output shaft carrying the motor housing is rotated, the inert mass of the motor may automatically act as an inertial damper, by which vibrations of the steering-shaft train may be effectively damped or suppressed without the necessity of further measures.

Therefore, the construction type of the present invention may provide friction reduction and vibration damping.

An example embodiment of the present invention may provide a servo unit at the steering-shaft train or at the corresponding steering system, the servo unit generally being able to be of a conventional construction type. In this manner, the hand forces necessary for operating the steering may be markedly reduced, e.g., in the case of slow driving and/or heavy vehicles.

Further features and aspects of the present invention are described below with reference to the drawings.

### BRIEF DESCRIPTION OF THE DRAWINGS

FIG. 1 is a schematic view of a vehicle steering system having the steering-shaft train according to an example embodiment of the present invention.

FIG. 2 illustrates a modified example embodiment of the present invention.

### DETAILED DESCRIPTION

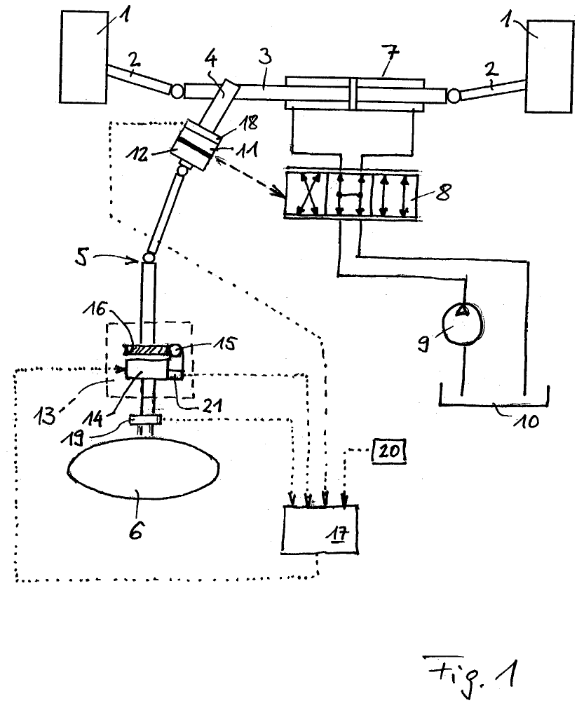

As illustrated in FIG. 1, a motor vehicle has steerable front wheels 1, which, for their steering movement, are connected by tie rods 2 to a gear rack and piston rod 3 movable in the transverse vehicle direction. Therefore, steerable front wheels 1 are deflected to the right or left as a function of the displacement direction of gear rack and piston rod 3.

Gear teeth arranged on gear rack and piston rod 3 mesh with a pinion 4, which is coupled by a steering-shaft train 5 to a steering wheel 6 controlled by the driver.

In addition, gear rack and piston rod 3 supports the piston of a hydraulic servomotor 7, which takes the form of a dual-action piston-cylinder unit and is controllably connectible to the pressure side of a servo pump 9 and a relatively nonpressurized hydraulic reservoir 8, by a proportional servo valve 8, in a generally conventional manner, the suction side of servo pump 9 also being connected to the hydraulic reservoir.

Servo valve 8 may be controlled in a conventional manner, as a function of the torque that is transmitted between steering-shaft train 5 and pinion 4. For this purpose, steering-shaft train 5 may have two parts 11 and 12, which may rotate relatively to each other in opposition to spring force and carry out a more or less large rotation with respect to each other in one direction or the other, as a function of the intensity or magnitude and direction of the torque transmitted. By coupling servo valve 8 to parts 11 and 12, it may be provided that servo valve 8 is driven in one direction or the other with respect to the normal position illustrated in FIG. 1, in accordance with the degree and the direction of the relative rotation between parts 11 and 12, and that servo motor 7 generates a correspondingly controllable servo force in one direction or the other for supporting the specific steering maneuver.

In addition, a transmitting device 13, which may take the form of an overriding-drive unit having an electric servomotor 14, is positioned in steering-shaft train 5, a transmission connection being formed by a shaft part 5′ on the side of the steering wheel and a further transmission connection being formed by a shaft part 5″ on the side of the wheels. A third transmission connection is positively coupled to the motor shaft of servomotor 14.

The housing of motor 14 may be stationary-mounted to shaft part 5′ or 5″. In the example embodiment illustrated in FIG. 1, shaft part 5″ on the side of the steering wheel supports the housing of servomotor 14.

Servomotor 14 or its motor shaft drives a worm 15, which interacts with a worm gear 16 arranged on the other shaft part, in this case, shaft part 5″ on the side of the wheels. In this context, worm 15 and worm gear 16 are arranged such that these parts interact with each other in a self-locking manner, i.e., worm 15 may only be rotated by servomotor 14, not by worm gear 16.

When servomotor 14 is switched off, shaft parts 5″ and 5″ are positively coupled to each other at a transmission ratio of 1:1, i.e., shaft parts 5′ and 5″ carry out equal angular displacements at the same angular velocity. When servomotor 14 is running in one rotational direction or the other, a more or less stepped-down or stepped-up gear ratio occurs between shaft parts 5′ and 5″ as a function of the rotational direction and angular velocity of motor 14, i.e., shaft part 5″ on the side of the wheels carries out a more rapid and larger angular displacement or a smaller and slower angular displacement in comparison with the rotational angle and the angular velocity of shaft part 5′ on the side of the steering wheel, i.e., of steering wheel 6. As a result, the ratio between the angular displacement of steering wheel 6 and the change in the steering angle of steered front wheels 1 changes.

An electronic control unit 17 may be used to control servomotor 14, the electronic control unit being able to be connected on the input side to a pinion-side angular-position sensor 19, a steering-wheel-side angular-position sensor 19, and a sensory system 20 for, e.g., any number of further parameters, and the electronic control unit changing the transmission ratio between steering wheel 6 and the steering movement of front wheels 1 in a predefined manner, as a function of parameters. In this context, the angular velocity and the angular displacement of servomotor 14 may be detected by an angular position sensor 21 on the side of the motor, so that automatic control by comparison of setpoint value to actual value is possible.

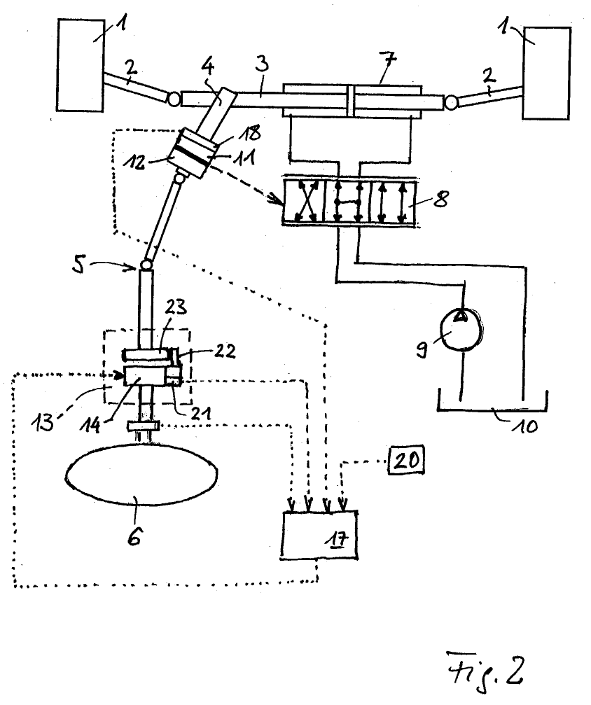

A difference between the example embodiment illustrated in FIG. 2 and the example embodiment illustrated in FIG. 1 is that servomotor 14 drives a pinion 22, which meshes in a non-self-locking manner with a gear wheel 23 that is mounted on shaft part 5″ in a rotatably fixed manner. In this case, servomotor 14 may have to function as a brake itself, or a brake assigned to servomotor 14 may become active, when a 1:1 gear ratio is to be ensured between shaft parts 5′ and 5″.

What is claimed is:

1. A steering-shaft train configured to be arranged between a steering handle and steered wheels of a vehicle steering system, comprising:
an input shaft arranged on a side of the handle;
an output shaft arranged on a side of the wheels; and
a transmission device including a motor and arranged to motively couple the input shaft and the output shaft at a transmission ratio controllable by the motor, a motor shaft of the motor positively coupled to a first one of the input shaft and the output shaft and a motor housing rotatably fixedly connected to a second one of the input shaft and the output shaft.

2. The steering-shaft train according to claim 1, wherein the transmission device includes one of self-locking gears and a self-locking transmission configured to positively couple the first one of the input shaft and the output shaft and the motor shaft.

3. The steering-shaft train according to claim 1, wherein the transmission device is configured to operate without play.

4. The steering-shaft train according to claim 1, further comprising a servomotor configured to motively connect to one of regulating units and actuators of the steered wheels, the servomotor controllable as a function of one of forces and torques transmitted between the output shaft and the steered wheels.

5. The steering-shaft train according to claim 1, wherein the first one of the input shaft and the output shaft and the motor shaft are coupled non-self-lockingly.

6. The steering-shaft train according to claim 5, wherein the motor includes a brake.

7. The steering-shaft train according to claim 6, wherein the brake is normally active and openable only by a supply of energy.

8. The steering-shaft train according to claim 1, wherein the transmission device includes a worm gear configured to positively couple the first one of the input shaft and the output shaft and the motor shaft.
